(19) United States
(12) Patent Application Publication
(10) Pub. No.: US 2016/0182683 A1
(43) Pub. Date: Jun. 23, 2016

(54) DYNAMIC SERVER/CLIENT TRANSITION FOR NETWORKED DEVICES

(71) Applicant: QUALCOMM Incorporated, San Diego, CA (US)

(72) Inventors: Tyler Byron Wear, San Diego, CA (US); Gaurav Gopal Kathuria, San Diego, CA (US); Rohit Tripathi, San Diego, CA (US); Siddharth Gupta, San Diego, CA (US); Chaitanya Pratapa, Hyderabad (IN)

(21) Appl. No.: 14/579,762

(22) Filed: Dec. 22, 2014

(51) Int. Cl. H04L 29/06; H04W 48/20; H04W 48/18; H04L 29/12

(52) U.S. Cl. CPC H04L 67/42; H04L 61/2015; H04L 67/40; H04W 48/20; H04W 48/18

(57) ABSTRACT

Homes, enterprises, and other facilities often have routers that receive internet connectivity through wired remote network connections, and this connectivity is provided to locally connected client devices. Smart phones and other wireless devices can serve as mobile access points that receive internet connectivity through different remote network connections (e.g., cellular networks). The mobile access points may also service client devices that may be different from those serviced by the routers. When a mobile access point is placed in a facility having a router, the local networks of the mobile access point and the router may be merged. Disclosed are systems and methods for dynamically selecting from multiple host devices (e.g., the router and the mobile access point) to provide internet connectivity for merged networks.

### BACKGROUND

1. Field of the Disclosure

The present application generally relates to networking technologies and, more specifically, to systems and methods for using multiple host devices and remote network connections to maintain network connectivity.

2. Description of Related Art

Homes, enterprises, and other facilities often receive internet connectivity via remote network connections provided by internet service providers (ISP). A facility's local network may be centrally managed by a host device such as a router, which assigns private internet protocol (IP) addresses to client devices within the facility, for example, through the Dynamic Host Configuration Protocol (DHCP). The router may also provide network address translation (NAT) to map the private IP addresses of the client devices within the local network to one or more public IP addresses assigned to the router.

A mobile access point is another type of host device that may provide internet connectivity to client devices over a broader range of physical locations than would be supported by a traditional (e.g., wired) router. Mobile access points may receive internet connectivity via remote network connections such as wide area network (WAN) connections and wireless local area network (WLAN) connections. Remote network connections may also be referred to as “backhaul connections” in some literature, and the two terms are used synonymously herein. A WAN may be implemented using cellular networks such as Long Term Evolution (4G LTE) networks or other wireless technologies such as the IEEE 802.16 protocol (WiMAX). Mobile access points are available as stand-alone devices and also through functionality provided by mobile devices (e.g., smart phones).

In recent times, cellular and other wireless networks have continued to improve in both connection speed and cost efficiency. As a result, mobile access points are becoming increasingly viable for providing internet connectivity within homes and other facilities.

### SUMMARY

In facilities having multiple host devices, such as a mobile access point and a router, the host devices may share an interface with one another. For example, the mobile access point may be docked in the router, which may also be referred to as a “cradle” in this context, such that internet traffic may flow between the mobile access point and the cradle. The mobile access point may defer control of the interface to the cradle if the cradle has an active remote network connection. As the “host” of the interface, the cradle may assign private IP addresses not only to the cradle's own client devices, but also to the mobile access point, which in this scenario may be considered one of the cradle's client devices. The mobile access point may accept the cradle as the host of the interface upon receiving the private IP address. The cradle may additionally provide network address translation (NAT) such that traffic from its remote network connection reaches the mobile access point and the cradle's other client devices. The mobile access point may also provide NAT such that traffic received from the cradle may reach the mobile access point's client devices. Accordingly, the mobile access point may maintain control over a separate subnet having the mobile access point's client devices, which provides the benefit of reducing the time and cost associated with reconfiguring the mobile access point's client devices after a transition between remote network connections, described further below. The dual-subnet arrangement also reduces the routing responsibilities (e.g., the size of the address table) of the cradle.

The shared interface between the mobile access point and the cradle may be bidirectional. For example, when the cradle's remote network connection fails, or when the cradle has internal issues (e.g., improper configuration), the cradle may no longer be able to provide an active internet connection to its client devices. The mobile access point may detect that it no longer receives internet connectivity from the cradle and may assign a private IP address to the cradle, thereby gaining control of the shared interface as the new host. The mobile access point may receive internet connectivity through its own remote network connections (e.g., WAN or WLAN) and may enable internet traffic to reach not only the mobile access point's own client devices, but also the cradle, which in this scenario may be considered one of the mobile access point's client devices. The cradle may maintain its own client devices and subnet when connected to the internet through the mobile access point.

Accordingly, the cradle and the mobile access point may each become a host of the shared interface depending, at least in part, on their relative capabilities to provide internet connectivity. Thus, the disclosed principles provide the advantage of maintaining an active internet connection for both host devices and their client devices even in the event that the cradle fails to provide this connectivity on its own (e.g., due to a failing wired remote network connection or improper network configuration).

The shared interface may be a USB interface, and internet traffic may be transmitted between the mobile access point and the cradle using an Ethernet-over-USB protocol.

Either (or both) of the mobile access point and the cradle may monitor the shared interface and/or their remote network connections to determine when to initiate a transition (e.g., establishing a new host and remote network connection).

### BRIEF DESCRIPTION OF THE DRAWINGS

Features, aspects, and embodiments of the disclosure are described in conjunction with the attached drawings, in which:

FIG. 1 shows a block diagram illustrating a system for providing network connectivity;

FIG. 2 shows a block diagram illustrating an arrangement wherein a cradle and a mobile access point both provide subnets and routing functionality within a facility;

FIG. 3 shows a block diagram illustrating an arrangement wherein the cradle serves as a network bridge while using an interface shared with the mobile access point as a remote network connection;

FIG. 4 shows a block diagram illustrating an arrangement wherein the mobile access point and the cradle both serve as network bridges;

FIG. 5 shows a flowchart illustrating an exemplary process for providing network connectivity;

FIG. 6 shows a flowchart illustrating an exemplary process wherein the mobile access point transitions from using its own remote network connection to using that of the cradle; and

FIG. 7 shows a flowchart illustrating an exemplary process wherein the mobile access point provides a remote network connection to the cradle through their shared interface.

These exemplary figures and embodiments are to provide a written, detailed description of the subject matter set forth by any claims in the present application. These exemplary figures and embodiments should not be used to limit the scope of any such claims.

Further, although similar reference numerals may be used to refer to similar structures for convenience, each of the various example embodiments may be considered to be distinct variations. When similar reference numerals are used, a description of the common elements may not be repeated, as the functionality of these elements may be the same or similar between embodiments. In addition, the figures are not to scale unless explicitly indicated otherwise.

### DESCRIPTION OF EMBODIMENT(S)

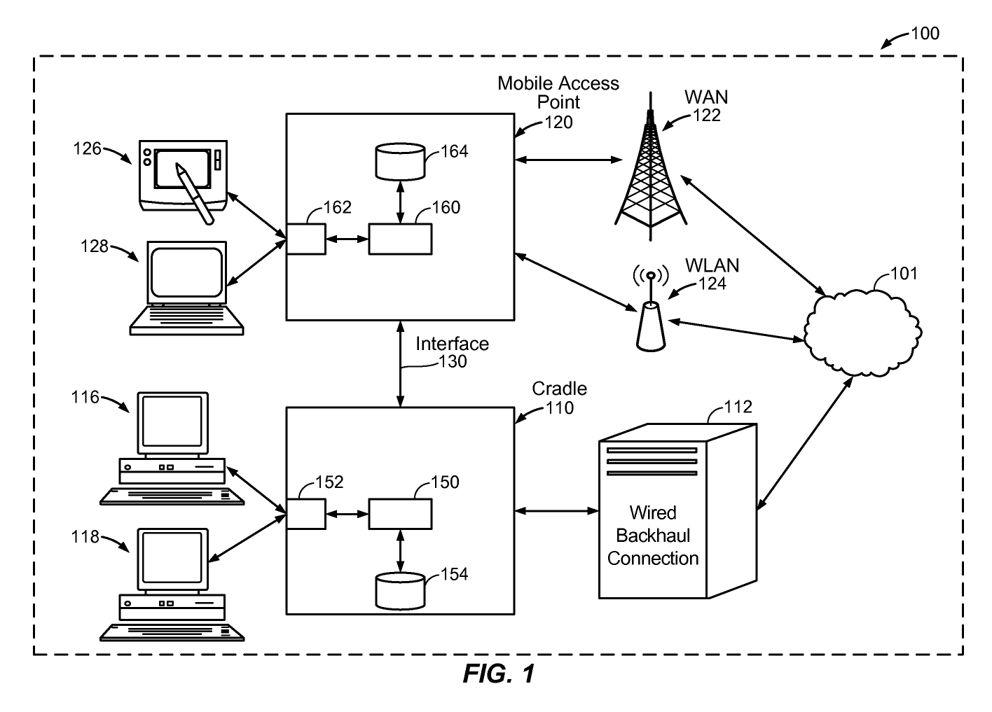

FIG. 1 shows a block diagram illustrating a system 100 for providing network connectivity. The system 100 may comprise a cradle 110 and a mobile access point 120, which may be independent devices that may connect to one another over an interface 130. The cradle 110 may be a stationary platform that is deployed within a facility such as a home or business enterprise, whereas the mobile access point 120 may be a movable platform that may provide wireless connectivity to nearby client devices. For example, the mobile access point 120 may be a portable device that may host a Wi-Fi hotspot to share internet connectivity with other devices.

The cradle 110 may connect to the internet 101 via a wired remote network connection 112 (also referred to as a wired backhaul connection 112), which may be provided by an internet service provider (ISP). In some embodiments, such as those where the cradle 110 is deployed in a rural environment with limited availability of wired internet connections, the cradle 110 may connect to the internet 101 via a wireless remote network connection or a powerline communication (PLC) connection to a remote network.

In some embodiments, the cradle 110 may act as the facility's primary router, such that the cradle 110 is the nearest routing node to a remote network (e.g., by being in communication or integrated with a DSL modem). In other embodiments, the cradle 110 may be connected to the internet 101 through a collocated router that serves as the primary gateway for the cradle's facility.

The cradle 110 may provide network connectivity to client devices 116, 118 within the facility through one or more adapters 152. For example, the adapter 152 may be an Ethernet or local area network (LAN) adapter comprising multiple ports that may be wired to the client devices 116 and 118, which may be desktop computers, servers, and/or other devices also having LAN adapters. The cradle 110 may additionally or alternatively provide internet connectivity to wireless client devices by using a wireless adapter.

The mobile access point 120 may be collocated with the cradle 110 during certain times such as when a user of the mobile access point 120 is at the facility having the cradle 110. At other times, the mobile access point 120 may be at a separate location from the cradle 110 and may still provide receive and internet connectivity. The mobile access point 120 may connect to the internet 101 via one or more remote network connections 122, 124, where each of the remote network connections 122, 124 may use different technologies and/or service providers. As shown in FIG. 1, the mobile access point 120 may use a wide area network (WAN) connection 122 and a wireless local area network (WLAN) connection 124 as remote network connections. The WAN connection 122 may comprise WiMAX connections, cellular connections (e.g., 4G LTE), and other types of remote network connections, that may be provided independently from the wired remote network connection 112 of the cradle 110. The WLAN connection 124 may, for example, be provided through a network using the IEEE 802.11 protocol (Wi-Fi). In some embodiments, when the mobile access point 120 is within range of the cradle 110, the mobile access point 120 may use a Wi-Fi network provided by the cradle 110. The mobile access point 120 may select one or more of the remote network connections 122, 124 based on a variety of factors including availability, relative bandwidth, and application or client requirements such as security requirements. For example, if the mobile access point 120 is involved in a secure transaction, the mobile access point 120 may use the WAN connection 122 to provide a relatively secure path for sending the sensitive data.

The mobile access point 120 may provide network connectivity to a plurality of client devices 126, 128 through one or more adapters 162. For example, the adapter 162 may be a WLAN adapter that provides connectivity to tablets, laptop computers, and other wireless devices (e.g., using Wi-Fi).

The mobile access point 120 and the cradle 110 may serve as independent host devices. Accordingly, the mobile access point 120 may provide internet connectivity to the client devices 126, 128 even when the mobile access point 120 is not in communication with the cradle 110. In these scenarios, the mobile access point 120 may use its independent remote network connection (e.g., the WAN connection 122) to access the internet 101 and provide internet connectivity to its client devices 126, 128. Similarly, the cradle 110 may use the wired remote network connection 112 to provide connectivity to its client devices 116, 118.

When in proximity, the mobile access point 120 and the cradle 110 may be connected with one another through an interface 130. The interface 130 may, for example, be an Ethernet-over-USB interface that may also provide power to the mobile access point 120 (e.g., when the mobile access point 120 is docked in the cradle 110). In some embodiments, the cradle 110 and the mobile access point 120 may additionally or alternatively connect to one another through a wireless interface, such as a Wi-Fi interface (e.g., if the cradle 110 provides the WLAN connection 124). This would allow the cradle 110 and the mobile access point 120 to maintain a network connection even when they are not physically connected to one another.

The cradle 110 and mobile access point 120 may each have routing engines 150, 160, respectively. The routing engines 150, 160 may provide the functionality of both Dynamic Host Configuration Protocol (DHCP) servers and DHCP clients. By acting as DHCP servers, the cradle 110 and the mobile access point 120 may provide the client devices 116, 118, 126, 128 with private internet protocol (IP) addresses. By acting as DHCP clients, the cradle 110 and the mobile access point 120 may receive IP addresses from one another depending on their connection modes, as will be described further below. In general, the mobile access point 120 and the cradle 110 may vary their relative DHCP server and client relationship over the shared interface 130.

When the mobile access point 120 is in communication with the cradle 110, the mobile access point 120 may use the interface 130 to supplement or replace the remote network connections 122, 124. The cradle 110 may accept the mobile access point 120 as a client device, and the cradle 110 may make provisions for the mobile access point 120 that are similar to those made for the client devices 116, 118 of the cradle 110. For example, the routing engine 150 of the cradle 110 may provide the client devices 116, 118 with private IP addresses within a subnet, and the mobile access point 120 may be provided a private IP address that is also within this subnet.

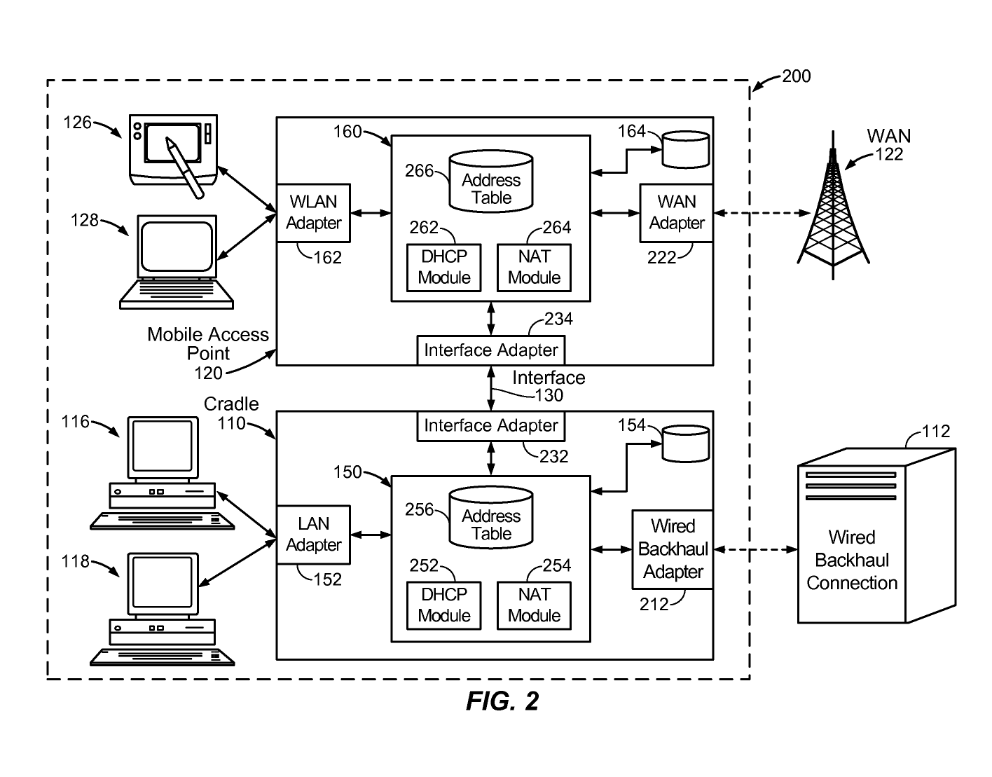

When the mobile access point 120 receives network connectivity from the cradle 110, the routing engine 160 of the mobile access point 120 may act as a DHCP client so that it may receive a private IP address from the cradle 110. The mobile access point's routing engine 160 may simultaneously serve as a DHCP server for its client devices 126, 128, thereby allowing the mobile access point 120 to maintain a separate subnet for the client devices 126, 128. The resulting dual-subnet topology provides numerous benefits such as the retention of private IP addresses for the client devices 126, 128 when the mobile access point 120 transitions from using one or more of the remote network connections 122, 124 to using the interface 130 for internet connectivity. If the client devices 116, 118, 126, and 128 are communicating with one another using their private IP addresses (e.g., by streaming within the local network provided by the mobile access point 120 and the cradle 110), the internal communications may have limited interruption (e.g., by not requiring reconfiguration) after the mobile access point 120 transitions from using one of the remote network connections 122, 124 to using the interface 130. Additionally, by providing network address translation and DHCP functionality, the mobile access point 120 may reduce the routing responsibilities of the cradle 110, so that the cradle 110 may store a single IP address for both the mobile access point 120 and its connected client devices 126, 128. The routing engines 150, 160 are described in further detail below with respect to FIGS. 2-4.

The shared interface 130 may permit the server/client (or host/client) relationship of the cradle 110 and the mobile access point 120 to be switched. Accordingly, the cradle 110 may become a client of the mobile access point 120 under certain conditions, as will be described further below.

The cradle 110 may comprise or be in communication with a memory device 154. The memory device 154 may have instructions which, when executed (e.g., by a processor), may provide the functionality described herein. Similarly, the mobile access point 120 may comprise or be in communication with a memory device 164 having instructions which, when executed (e.g., by a processor), may provide the functionality described herein.

FIG. 2 shows a block diagram illustrating an arrangement wherein a cradle 110 and a mobile access point 120 both provide subnets and routing functionality within a facility 200.

The cradle 110 may receive a wired remote network connection 112 through a wired remote network adapter 212 (also referred to as a wired backhaul adapter 212). As described above, this connection may be provided by an internet service provider (ISP), and the cradle 110 may serve as the primary gateway for the facility 200 (e.g., a home).

The cradle 110 may comprise a routing engine 150 that may provide network address translation (NAT) and other routing functionality to enable the client devices 116, 118 to communicate with other devices, both over the internet and within the local network of the facility 200 provided by the cradle 110 and, when applicable, the mobile access point 120. The routing engine 150 may use a DHCP module 252 that acts as a DHCP server to assign private IP addresses to the client devices 116, 118 and, depending on the selected connection modes, to the mobile access point 120. As will be described further below, the DHCP module 252 may also act as a DHCP client to receive a private IP address from the mobile access point 120 in other connection modes. The routing engine 150 may also comprise a NAT module 254 which may relate the assigned private IP addresses to public IP addresses contained in internet traffic received by the cradle 110. At any given time, one or more public IP addresses may be allocated to the cradle 110 and/or the mobile access point 120 from internet service providers (ISP), telecommunications infrastructure providers, and other service providers. The routing module 150 may further comprise an address table 256 for storing the relationships between the public IP address and the private IP addresses. The address table 256 may also store and map port numbers of incoming traffic to private IP addresses. The routing engine 150 may operate based on instructions read from a memory device 154.

The mobile access point 120 may be operable to connect with the cradle 110 over an interface 130. The mobile access point 120 may comprise a wide area network (WAN) adapter 222 for receiving internet connectivity and a public IP address through a WAN connection 122. The WAN connection 122 may, for example, be provided by a base station in a cellular network.

The mobile access point 120 may further comprise a wireless local area network (WLAN) adapter 162 for communicating with client devices 126, 128. In some embodiment where WLAN technology is used for a remote network connection, the WLAN adapter 162 may additionally or alternatively connect to a remote network.

Like the cradle 110, the mobile access point 120 may similarly include a routing engine 160 for enabling routing functions that may be autonomous from those of the cradle 110. That is, the routing engine 160 may comprise a DHCP module 262 that may act as both a DHCP client and a DHCP server. When acting as a DHCP client, the DHCP module 262 may request for and receive a private IP address from the cradle 110, where the received private IP address may be within the cradle's subnet and may become associated with the mobile access point 120. As a DHCP server, the DHCP module 262 may assign private IP addresses to the client devices 126, 128 in a separate subnet than that created by the cradle 110. The routing engine 160 may further comprise a network address translation module 264 and an address table 266 that preform similar functions to those in the cradle 110.

In accordance with the disclosed principles, the interface 130 provides for switching the server/client relationship of the cradle 110 and the mobile access point 120, thereby permitting bidirectional assignments of IP addresses. This provides the benefit of preserving network connectivity for the mobile access point 120, the cradle 110, and their client devices as long as either the cradle 110 or the mobile access point 120 have an active remote network connection (e.g., via the WAN connection 122, or the wired remote network connection 112). As a result, even if the wired remote network connection 112 fails, the client devices 116, 118 of the cradle 110 may maintain internet connectivity through the mobile access point 120 and its remote network connection 122. IP address assignment may entail either or both of Internet Protocol version 4 (IPv4) and Internet Protocol version 6 (IPv6).

The cradle 110 may have an interface adapter 232 that enables the cradle 110 to communicate over the interface 130 with the mobile access point 120. Similarly, the mobile access point 120 may have an interface adapter 234 that enables the mobile access point 120 to communicate over the interface 130 with the cradle 110.

The cradle 110 may use the interface adapter 232 and the routing engine 150 to detect when the mobile access point 120 fails to provide internet connectivity. Similarly, the mobile access point 120 may use the interface 234 and the routing engine 160 to sense connectivity failure of the cradle 110. One technique for a host device (e.g., the cradle 110 or the mobile access point 120) to establish the connectivity state of the opposing host device (e.g., on the other side of the shared interface 130) comprises using a routing engine 150, 160 to send a ping message to an external server through the opposing host device. The interface adapters 232 and 234 may determine that the opposing host devices 120 and 110, respectively, have active remote network connections if a response to the ping message is received. In some embodiments, an external server may be configured to periodically send heartbeat messages. If the interface adapter 234 fails to receive a heartbeat message through the cradle 110 within an expected time period, the mobile access point 120 may assume that the cradle 110 has an inactive remote network connection that does not provide internet connectivity. The cradle 110 may perform a similar test to determine whether or not the mobile access point 120 has an active remote network connection (and, thus, internet connectivity).

In some embodiments, the cradle 110 and/or the mobile access point 120 may recognize when they themselves do or do not provide a suitable internet connection and may proactively alert each other about their instantaneous or expected capabilities and incapabilities. For example, the cradle 110 may assign a private IP address to the mobile access point 120 when the cradle 110 has an active internet connection. The mobile access point 120 may interpret the cradle's IP address assignment as indicating that the cradle 110 has an active remote network connection (and is capable of providing internet connectivity). The mobile access point 120 may similarly assign a private IP address to the cradle 110 when the mobile access point 120 has an active remote network connection.

Each host device 110, 120 may use the connectivity state of the other host device 110, 120 when making decisions such as choosing a remote network connection. In general, either host devices 110, 120 may use the interface 130 to the other host device 110, 120 as a remote network connection. When choosing a remote network connection, each host device 110, 120 may consider the relative efficiency or simply the availability of the remote network connections collectively available to the host devices (e.g., the wired remote network connection 112 and the WAN connection 122).

For example, while the wired remote network connection 112 may provide relatively high speeds and cost efficiencies compared to the WAN connection 122, the cradle 110 may occasionally lose internet connectivity through the wired remote network connection 112. This potential disruption in service may be caused by a failure of the wired remote network connection 112, misconfiguration of the cradle 110 or other devices in the facility's local network, or a limitation on the wired remote network connection 112 due to approaching or exceeding a periodic (e.g., monthly) bandwidth budget. In accordance with the disclosed principles, the cradle 110 may use the interface 130 to maintain internet connectivity for its client devices 116, 118 through the mobile access point 120. When receiving internet connectivity through the mobile access point 120, the cradle 110 may maintain, through the routing module 150, a separate subnet from the mobile access point 120, such that the cradle 110 manages routing of internet and local traffic for the client devices 116, 118, and the mobile access point 120 receives requests from a single private IP address associated with the cradle 110. As mentioned above, this arrangement reduces the time and cost associated with reconfiguring the client devices 116, 118 after a transition between remote networks.

As another example, the mobile access point 120 may determine that the internet connectivity provided through the interface 130 is faster and/or more cost effective than that from the WAN connection 122. Accordingly, the mobile access point 120 may optionally disable the WAN adapter 222 and instead use the interface adapter 234 to receive internet connectivity from the wired remote network connection 112 through the cradle 110. The mobile access point's DHCP module 262 may act as a DHCP client to request a private IP address from the cradle 110, while also acting as a DHCP server to provide private IP addresses to the mobile access point's client devices 126, 128 in a separate subnet from that of the cradle 110.

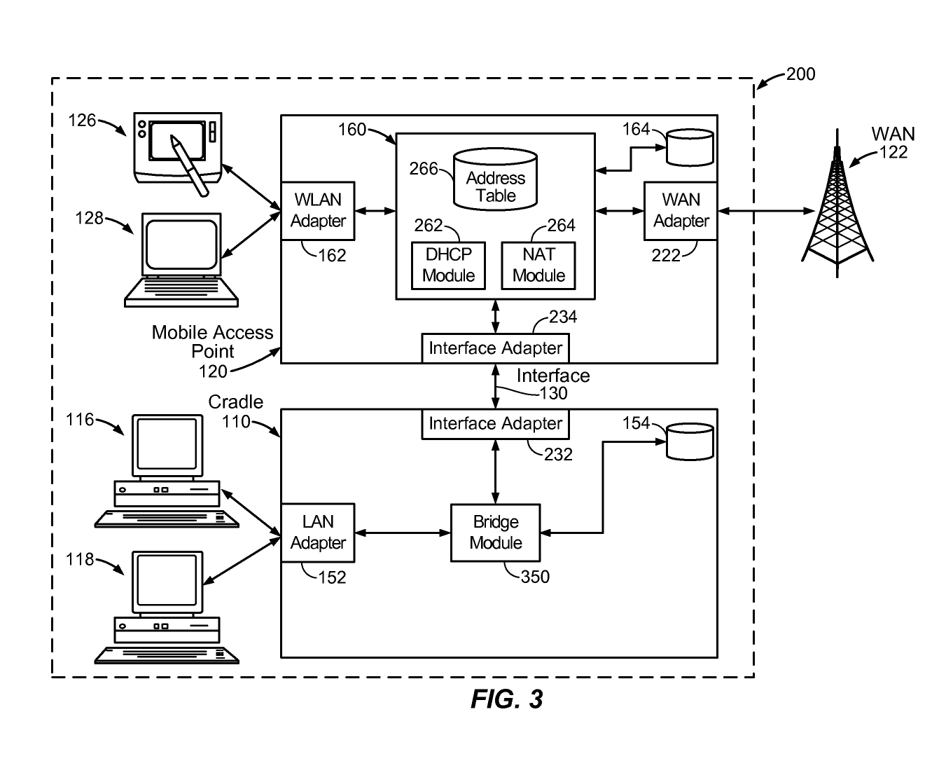

FIG. 3 shows a block diagram illustrating an arrangement wherein the cradle 110 serves as a network bridge while using an interface 130 shared with the mobile access point 120 as a remote network connection.

As described above, the mobile access point 120 may detect when the cradle 110 is not able to provide an active remote network connection. Upon discovering such a scenario or when prompted by the cradle 110, the mobile access point 120 may alter the server/client (or host/client) relationship of the shared interface 130 such that the mobile access point 120 becomes the host of the shared interface 130. As a host, the mobile access point 120 may provide the cradle 110 with one or more private IP addresses and with internet connectivity (e.g., as established through the mobile access point's WAN connection 122). Accordingly, the cradle 110 may use the shared interface 130 between the cradle 110 and the mobile access point 120 as a remote network connection.

In the mode described in FIG. 3, the cradle 110 may use a bridge module 350, which may provide reduced or lower layer functionality than the routing engines described in FIGS. 1 and 2. The bridge module 350 may provide functionality in the data link layer (e.g., Layer 2 of the Open Systems Interconnection (OSI) model) to join a network segment having the cradle 110 and its client devices 116, 118 to a network segment having the mobile access point 120 and its client devices 126, 128, thereby forming a single network segment. The bridge module 350 may be in communication with a memory device 154 having instructions which, when executed (e.g., by a processor), may provide the functionality described herein.

When the cradle 110 is in a bridge mode (e.g., by using the bridge module 350), the mobile access point 120 may be exposed to the cradle's client devices 116, 118. Accordingly, the mobile access point 120 may assign private IP addresses to the client devices 116, 118, instead of assigning a single private IP address to the cradle 110 and leaving the cradle 110 to manage the private IP addresses associated with the client devices 116, 118 in another subnet. As a result, the mobile access point 120 may serve as a router for a single subnet within the facility 200, where the subnet may comprise the mobile access point 120, its client devices 126, 128, and the client devices 116, 118 that are connected through the cradle 110. In some embodiments, the cradle 110 itself may also receive an IP address when in the bridge mode, which may be useful for the mobile access point 120 to address and configure the bridge module 350.

The mobile access point 120 may further provide network address translation to map each of the private IP addresses within the subnet of the facility 200 to one or more public IP addresses assigned to the mobile access point 120 over the WAN connection 122. The mobile access point 120 may store the mapping information in an address table 266.

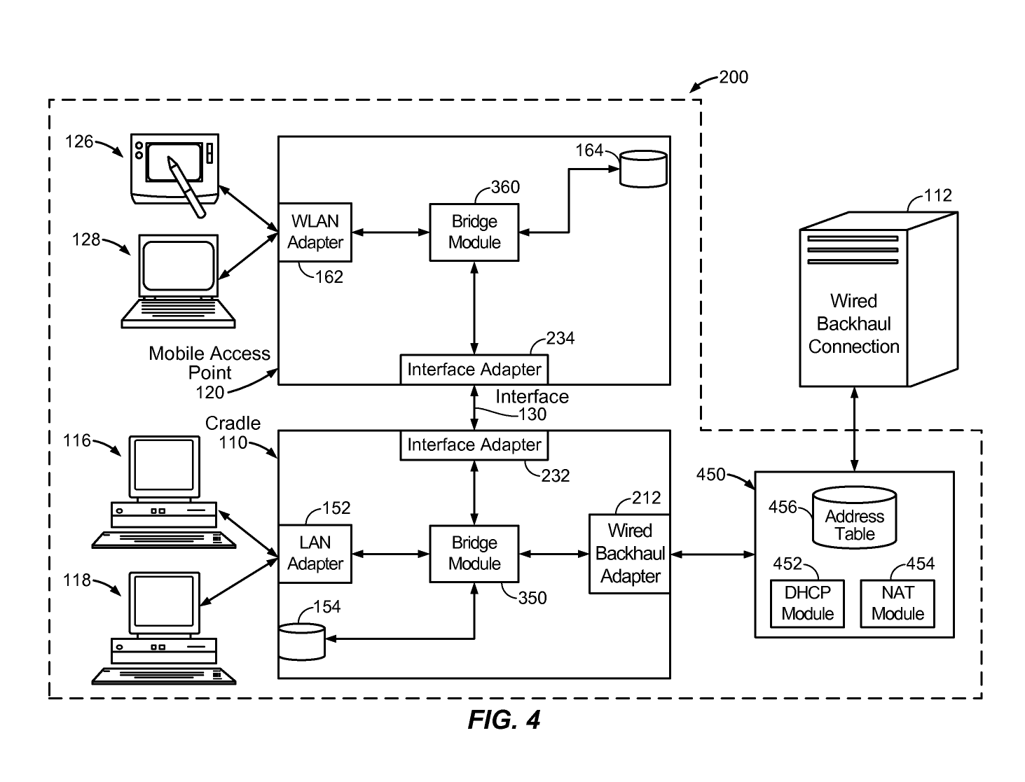

FIG. 4 shows a block diagram illustrating an arrangement wherein the mobile access point 120 and the cradle 110 both serve as network bridges. As discussed above, the cradle 110 may connect to a wired remote network connection through a router 450. This arrangement may be beneficial if a user wishes to maintain centralized IP administration from a known or pre-existing device other than the cradle 110 and the mobile access point 120. The cradle 110 and the mobile access point 120, both acting in bridge modes, may provide bridge modules 350 and 360, respectively, which may join all devices within the facility 200 into a single subnet.

The router 450 may assign private IP addresses to the client devices 116, 118, 126, 128 of both the cradle 110 and the mobile access point 120 using a DHCP module 452. The router 450 may further comprise a NAT module 254 to map the assigned private IP addresses to one or more public IP addresses associated with the router 450, as well as ports used by each application and/or device. The relationship between the private IP addresses and the public IP address (or addresses) and ports may be stored in an address table 456 of the router 450.

While various modes and arrangements are provided in FIGS. 1-4, it is to be understood that other modes and arrangements are possible. In some embodiments, a user may trigger a mode transition. For example, the cradle may have a switch that dictates whether the cradle receives connectivity through the interface adapter (e.g., a USB connection) in communication with the mobile access point or through the wired remote network adapter (e.g., a LAN connection). In some embodiments, the modes of the cradle and/or the mobile access point may change based on network conditions detected by either the cradle, the mobile access point, or both. For example, the mobile access point may detect when it loses internet connectivity through the cradle, which may prompt the mobile access point to provide a private IP address to the cradle and to begin communicating over a WAN connection in a router mode.

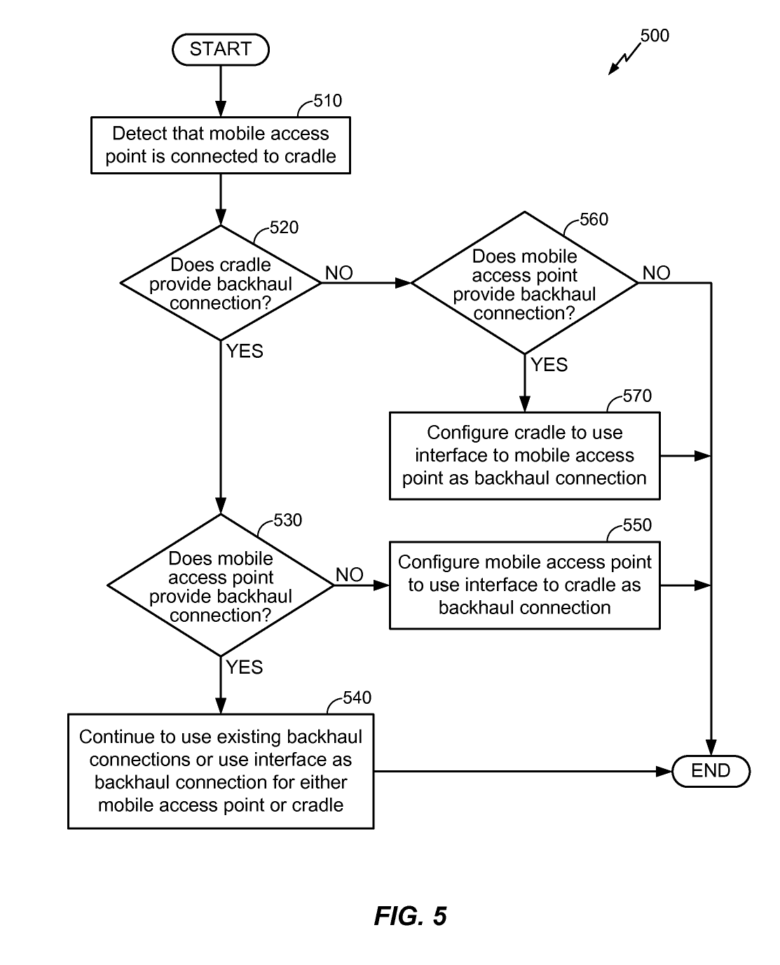

FIG. 5 shows a flowchart illustrating an exemplary process 500 for providing network connectivity. At an action 510, a mobile access point may detect that it is connected to a cradle. For example, the mobile access point may have a USB interface adapter that may begin to receive power when the mobile access point is connected to the cradle, and the detection of this power may be used to determine that the mobile access point is connected to the cradle.

At an action 520, the mobile access point may determine whether or not the cradle provides a connection to a remote network such as the internet. As described above, in some embodiments, the mobile access point may send a ping message over the cradle to determine whether or not the cradle can provide internet connectivity. Alternatively or additionally, the mobile access point may listen for a heartbeat message from an external server through the cradle, or the cradle may detect the state of its own remote network connection and provide this state information to the mobile access point upon connection. Other techniques may be used to determine or convey the state of the cradle's remote network connection. If the mobile access point determines that the cradle does provide a remote network connection, the process 500 may proceed to an action 530. Otherwise the process may proceed to an action 560.

The determination of the cradle's remote network connectivity (as described in action 520) may repeatedly occur while the mobile access point is in communication with the cradle and not simply when the mobile access point first detects a connection to the cradle. Accordingly, the mobile access point and cradle may adapt as their respective remote network connections change over time.

At the action 530, the mobile access point may determine whether or not it has access to a usable remote network connection (e.g., one that is not provided by the cradle). The mobile access point may ping an external interface or listen for a heartbeat message through its one or more remote network connections. If the mobile access point determines that it does not have a usable remote network connection, the process 500 may proceed to an action 550. Otherwise, the process may proceed to an action 540.

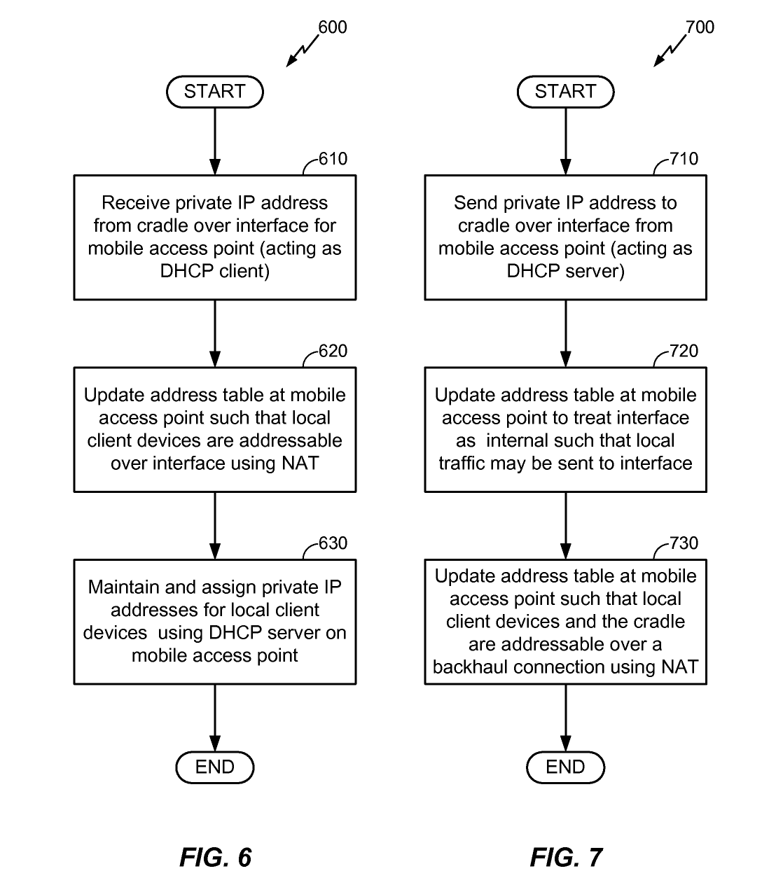

At the action 550, the mobile access point may have determined that it does not have its own remote network connection, but also that the cradle does provide an active remote network connection. Accordingly, the mobile access point may switch to a “cradle mode,” where it may receive internet connectivity through the cradle and the cradle's remote network connection. As a result, the mobile access point may receive a private IP address through the interface shared with the cradle. Furthermore, in some embodiments, the mobile access point may retain control over its subnet and client devices' private IP addresses, such that the cradle may provide a single IP address to the mobile access point, and the mobile access point may route traffic to its own client devices. In other embodiments, the mobile access point may switch to a bridge mode where it surrenders control over its own client devices and allows the cradle to assign all private IP addresses. This provides increased control to the cradle but may increase transition times associated with changing remote network connections due to the greater amount of reconfiguration. An exemplary process for transitioning the mobile access point from using its own remote network connection to using that of the cradle through the shared interface is described in further detail below with respect to FIG. 6.

At the action 540, the mobile access point may have determined that both the cradle and the mobile access point itself provide usable remote network connections for establishing internet connectivity. Accordingly, the mobile access point may have the choice of either retaining its remote network connection or transitioning to the remote network connection of the cradle. In some embodiments, the mobile access point may default to the cradle's remote network connection whenever it is available, as the cradle's remote network connection may be assumed to provide higher connection speeds and lower costs than the mobile access point's remote network connection(s). In other embodiments, the mobile access point may perform further testing to determine the relative speed, cost efficiency, and/or other metrics before determining whether or not to use the cradle's remote network connection.

In some embodiments, when a client device of either the cradle or the mobile access point requests to perform a secure transaction or another process having sensitive data, a remote network connection (and potentially a new host of the shared interface) may be selected to provide the most secure path for sending the sensitive data. For example, a client device of the cradle may request a secure transaction, which may prompt the mobile access point to become the host of the shared interface. The cradle's client device may thus benefit from increased security of the mobile access point's secure remote network connection, such as an LTE backhaul connection.

At the action 560, the mobile access point may have already determined that the cradle does not provide an active remote network connection and may then determine the status of its own remote network connection. If the mobile access point determines that it too is lacking an active remote network connection (e.g., capable of providing internet connectivity), the process 500 may end. However, if the mobile access point determines that it does have an active remote network connection, the process 500 may proceed to an action 570.

At the action 570, the mobile access point may share its remote network connection and internet connectivity with the cradle that was previously determined to not have internet connectivity. Due to the bidirectional nature of the shared interface, the mobile access point may provide a private IP address to the cradle, such that the cradle and client devices connected to the cradle may receive internet connectivity through the mobile access point. An exemplary process for providing a remote network connection to the cradle through the mobile access point is described in FIG. 7. Following the configuration of the cradle in the action 570, the process 500 may end. However, the cradle and/or the mobile access point may periodically check whether the cradle's remote network connection begins to provide internet connectivity (e.g., as described in the action 520) so as to promote cost efficiency, connection speed, and/or improvement by another metric.

FIG. 6 shows a flowchart illustrating an exemplary process 600 wherein the mobile access point transitions from using its own remote network connection to using that of the cradle. At an action 610, the mobile access point may receive a private IP address from the cradle over a shared interface. By receiving a private IP address over the shared interface, the mobile access point may detect or verify that the cradle has a valid remote network connection. For example, the cradle and the mobile access point may each agree to only assign private IP addresses over the shared interface if they have an active remote network connection.

The shared interface may, for example, be an Ethernet-over-USB interface. Numerous protocols for implementing Ethernet over USB exist such as the Ethernet Control Model (ECM), which delivers Ethernet frames as packets over a physical USB connection.

At an action 620, the mobile access point may update its address table such that network address translation is applied to the shared interface instead of to a remote network connection that was most recently used. Accordingly, outgoing traffic from the mobile access point and client devices connected to the mobile access point may use the shared interface instead of the previous remote network connection (e.g., provided by an LTE network). Additionally, the incoming traffic from the shared interface may be directed to either the mobile access point or its connected client devices.

In some embodiments, the mobile access point may store entries relating to the previous remote network connection so that it may more easily revert if needed (assuming these entries are still valid).

At an action 630, the mobile access point may maintain control of its client devices, which may entail preserving the mobile access point's existing subnet. The mobile access point may also provide a DHCP server for its client devices such that the mobile access point can renew and provide new private IP addresses to client devices that connect to the internet through the mobile access point. By maintaining a separate subnet from the cradle, the mobile access point reduces the routing effort required by the cradle, as the cradle may only need to keep track of one private IP address representative of the mobile access point and all of the mobile access point's client devices. Furthermore, the client devices of the mobile access point may retain their private IP addresses, thereby reducing the need for reconfiguration and the processing and time costs of changing the mobile access point's remote network connection.

FIG. 7 shows a flowchart illustrating an exemplary process 700 wherein the mobile access point provides a remote network connection to the cradle through their shared interface. At an action 710, the mobile access point may send a private IP address to the cradle over the shared interface, thereby acting as a DHCP server. This may signal to the cradle that the mobile access point is able to provide a remote network connection.

The cradle, acting as a DHCP client, may accept the private IP address from the mobile access point. The cradle may maintain control over its client devices and provide network address translation (NAT) within the cradle's subnet such that the mobile access point may store only one IP address for the cradle and its client devices.

At an action 720, the mobile access point may update its address table to indicate that the shared interface may be used as an internal interface or connection. Accordingly, the mobile access point may direct traffic to the cradle over the shared interface much like the mobile access point would for its own client devices. The address table may also indicate that outbound traffic (e.g., to the internet) may not be sent over the shared interface.

At an action 730, the mobile access point may further update its address table to apply NAT to a remote network connection (e.g., a WAN connection) having internet connectivity, instead of the shared interface, if the shared interface was previously used. By applying NAT to an active remote network connection, the mobile access point may send outgoing traffic from the client devices and the cradle to the internet, and the mobile access point may also forward incoming traffic to the correct client devices and the cradle over the shared interface.

While various embodiments in accordance with the disclosed principles have been described above, it should be understood that they have been presented by way of example only, and are not limiting. Thus, the breadth and scope of the disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It is contemplated that the Dynamic Host Configuration Protocol (DHCP) modules, network address translation (NAT) modules, address tables, routing engines, adapters and other elements be provided according to the structures disclosed herein in integrated circuits of any type to which their use commends them, such as ROMs, RAM (random access memory) such as DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as digital signal processors (DSP), graphics system processors (GSP), synchronous vector processors (SVP), image system processors (ISP), as well as testability and emulation circuitry for them, all represent sites of application of the principles and structures disclosed herein.

Implementation is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

A networked computing environment may include, but is not limited to, computing grid systems, distributed computing environments, cloud computing environment, etc. Such networked computing environments include hardware and software infrastructures configured to form a virtual organization comprised of multiple resources which may be in geographically disperse locations.

Various terms used in the present disclosure have special meanings within the present technical field. Whether a particular term should be construed as such a “term of art” depends on the context in which that term is used. “Connected to,” “in communication with,” “associated with,” or other similar terms should generally be construed broadly to include situations both where communications and connections are direct between referenced elements or through one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “immediately,” “equivalent,” “during,” “complete,” “identical,” and the like should be understood to mean “substantially at the time,” “substantially immediately,” “substantially equivalent,” “substantially during,” “substantially complete,” “substantially identical,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the subject matter set forth in any claims that may issue from this disclosure. Specifically and by way of example, although the headings refer to a “Field of the Disclosure,” such claims should not be limited by the language chosen under this heading to describe the so-called technical field. Further, a description of a technology in the “Background” is not to be construed as an admission that technology is prior art to any subject matter in this disclosure. Neither is the “Summary” to be considered as a characterization of the subject matter set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A method for providing internet connectivity in a network, the method comprising:
receiving, by a first host device, internet connectivity through a first remote network connection in response to determining the first remote network connection is active, wherein the first host device is associated with a first subnet for supporting a first client device; and
receiving, by the first host device, internet connectivity through a shared interface between the first host device and a second host device via a second remote network connection of the second host device in response to determining the first remote network connection is inactive, wherein the second host device is associated with a second subnet for supporting a second client device, and wherein the first host device maintains the first subnet and continues to support the first client device regardless of whether the first host device is receiving internet connectivity via the first remote network connection or through the shared interface via the second remote network connection.

2. The method of claim 1, further comprising:
providing, by the first host device, a first internet protocol (IP) address to the first client device,
wherein the first client device maintains the first IP address regardless of whether the first host device is receiving internet connectivity via the first remote network connection or through the shared interface via the second remote network connection.

3. The method of claim 1, further comprising:
listening, at the first host device, for a heartbeat message from an external server through the shared interface,
wherein the first host device reverts to receiving internet connectivity through the first remote network connection and provides internet connectivity to the second host device via the shared interface after the first host device fails to receive the heartbeat message within an expected time period.

4. The method of claim 1:
wherein the second host device is a host of the shared interface when the second remote network connection of the second host device is in use; and
wherein the first host device becomes the host of the shared interface after determining that the second remote network connection is inactive.

5. The method of claim 4, further comprising:
providing, by the first host device, network address translation for the first subnet both when the first host device is the host of the shared interface and when the second host device is the host of the shared interface.

6. The method of claim 1, wherein the first host device signals to the second host device that the first host device is ready to provide internet connectivity to the second host device by assigning an internet protocol (IP) address to the second host device over the shared interface.

7. The method of claim 1, wherein the first host device is triggered to begin using the first remote network connection to provide internet connectivity to the second host device by a request for secure communication from one of the first client device and the second client device.

8. The method of claim 1, wherein the first host device is a mobile access point and the second host device is a router.

9. The method of claim 1, wherein the first remote network connection is a cellular connection and the second remote network connection is a wired connection.

10. The method of claim 1, wherein the first host device is connected to the second host device using an Ethernet-over-USB protocol.

11. The method of claim 1, wherein the first subnet and the second subnet are each accessible by a plurality of client devices.

12. A host device for providing internet connectivity in a network, the host device comprising:
a remote network adapter operable to receive internet connectivity from a first remote network connection;
a local network adapter operable to support a first client device in a first subnet;
an interface adapter operable to establish communication with another host device over a shared interface, the other host device operable to support a second client device in a second subnet and to have a second remote network connection,
wherein the interface adapter is further operable to receive internet connectivity via the second remote network connection of the other host device; and
a routing engine operable to determine that the second remote network connection is inactive,
wherein the interface adapter is further operable to provide internet connectivity to the other host device in response to the routing engine determining that the second remote network connection is inactive.

13. The host device of claim 12:
wherein the other host device is a host of the shared interface when the second remote network connection of the other host device is in use; and
wherein the host device becomes the host of the shared interface after the routing engine determines that the second remote network connection is inactive.

14. The host device of claim 13, wherein the routing engine provides network address translation for the first subnet both when the host device is the host of the shared interface and when the other host device is the host of the shared interface.

15. The host device of claim 13, wherein the host device is triggered to become the host of the shared interface by a request for secure communication from one of the first client device and the second client device.

16. The host device of claim 13, wherein the host device is operable to signal to the other host device that the host device is ready to provide internet connectivity to the other host device by assigning an internet protocol (IP) address to the other host device over the shared interface.

17. A host device for providing internet connectivity in a network, the host device comprising:
means for receiving internet connectivity from a first remote network connection;
means for supporting a first client device in a first subnet;
means for establishing communication with another host device over a shared interface, the other host device operable to support a second client device in a second subnet, the other host device further operable to have a second remote network connection;
means for receiving internet connectivity via the second remote network connection of the other host device;
means for determining that the second remote network connection is inactive; and
means for providing internet connectivity to the other host device in response to determining that the second remote network connection is inactive.

18. The host device of claim 17:
wherein the other host device is a host of the shared interface when the second remote network connection of the other host device is in use; and
wherein the host device becomes the host of the shared interface when the second remote network connection is inactive.

19. The host device of claim 18, further comprising:
means for providing network address translation for the first subnet both when the host device is the host of the shared interface and when the other host device is the host of the shared interface.

20. The host device of claim 18, wherein the host device is triggered to become the host of the shared interface by a request for secure communication from one of the first client device and the second client device.

21. The host device of claim 17, further comprising:
means for signaling to the other host device that the host device is ready to provide internet connectivity to the other host device.

22. A computer program product comprising a machine-readable medium having instructions stored thereon, the instructions executable by one or more processors for:
receiving, by a first host device, internet connectivity through a first remote network connection in response to determining the first remote network connection is active, wherein the first host device is associated with a first subnet for supporting a first client device; and
receiving, by the first host device, internet connectivity through a shared interface between the first host device and a second host device via a second remote network connection of the second host device in response to determining the first remote network connection is inactive, wherein the second host device is associated with a second subnet for supporting a second client device, and wherein the first host device maintains the first subnet and continues to support the first client device regardless of whether the first host device is receiving internet connectivity via the first remote network connection or through the shared interface via the second remote network connection.

23. The computer program product of claim 22, wherein the instructions are further executable by the one or more processors for:
providing, by the first host device, a first internet protocol (IP) address to the first client device,
wherein the first client device maintains the first IP address regardless of whether the first host device is receiving internet connectivity via the first remote network connection or through the shared interface via the second remote network connection.

24. The computer program product of claim 22, wherein the instructions are further executable by the one or more processors for:
listening, at the first host device, for a heartbeat message from an external server through the shared interface; and
wherein the first host device reverts to receiving internet connectivity through the first remote network connection and provides internet connectivity to the second host device via the shared interface after the first host device fails to receive the heartbeat message within an expected time period.

25. The computer program product of claim 22,
wherein the second host device is a host of the shared interface when the second remote network connection of the second host device is in use; and
wherein the first host device becomes the host of the shared interface after determining that the second remote network connection is inactive.

26. The computer program product of claim 25, wherein the instructions are further executable by the one or more processors for:
providing, by the first host device, network address translation for the first subnet both when the first host device is the host of the shared interface and when the second host device is the host of the shared interface.

27. The computer program product of claim 22, wherein the first host device signals to the second host device that the first host device is ready to provide internet connectivity to the second host device by assigning an internet protocol (IP) address to the second host device over the shared interface.

28. The computer program product of claim 22, wherein the first host device is triggered to begin using the first remote network connection to provide internet connectivity to the second host device by a request for secure communication from one of the first client device and the second client device.

29. A method for providing internet connectivity in a network, the method comprising:
establishing, by a first host device, communication over a shared interface between the first host device and a second host device, the first host device having a first remote network connection and the second host device having a second remote network connection;
receiving, by the first host device, a first internet protocol (IP) address from the second host device over the shared interface between the first host device and the second host device; and
providing, by the first host device, a second IP address to the second host device over the shared interface in response to a determination that the second remote network connection is inactive.

30. The method of claim 29, further comprising:
providing, by the first host device, a first subnet for supporting a first client device, the first subnet being different from a second subnet provided by the second host device for supporting a second client device.

31. The method of claim 30, wherein the first host device maintains the first subnet and continues to support the first client device regardless of whether the first host device is receiving internet connectivity via the first remote network connection or through the shared interface via the second remote network connection.

32. The method of claim 29:
wherein the second host device is a host of the shared interface when the second remote network connection of the second host device is in use; and
wherein the first host device becomes the host of the shared interface after the determination that the second remote network connection is inactive.

33. The method of claim 30, further comprising:
providing, by the first host device, network address translation for the first subnet both when the first host device is a host of the shared interface and when the second host device is the host of the shared interface.

34. The method of claim 29, wherein the first host device signals to the second host device that the first host device is ready to provide internet connectivity to the second host device by assigning the second IP address to the second host device over the shared interface.
